(19) United States
(12) Patent Application Publication
(10) Pub. No.: US 2011/0247463 A1
(43) Pub. Date: Oct. 13, 2011

(54) Socket wrench assembly

(76) Inventor: Hsiu E. Yu, Taichung (TW)

(21) Appl. No.: 12/798,849

(22) Filed: Apr. 13, 2010

(51) Int. Cl. B25B 13/06; B25B 23/16

(52) U.S. Cl. 81/124.3; 81/124.4

(57) ABSTRACT

A socket wrench assembly includes three drive shanks each having a bore and each having a socket member attached to the outer end, and each having a smaller compartment and a greater non-circular chamber formed in the socket member, and the inner end portions of the drive shanks are secured together to form a Y-shaped or T-shaped structure for allowing either of the drive shanks to be driven or rotated by the other drive shanks with a greater driving torque, and the chambers of the socket members include inner diameters different from each other for receiving or engaging with or for driving tool members of different dimensions or sizes.

### BACKGROUND OF THE INVENTION

1. Field of the Invention

The present invention relates to a socket wrench assembly, and more particularly to a socket wrench assembly including three extensions secured together and having socket members of different dimensions or sizes or socket openings for driving tool members of different dimensions or sizes.

2. Description of the Prior Art

Typical socket wrenches comprise a socket member having a socket opening for receiving or engaging with a nut or fastener or other tool members, and a driving handle coupled to the socket member for driving or rotating the nut or fastener or other tool members with the socket member.

For example, U.S. Pat. No. 845,717 to Miller discloses one of the typical socket wrenches comprising a T-coupling coupled to a socket member with a sleeve coupling.

However, the socket opening of the socket member may only be used to receive or engage with a nut or fastener or tool member of a predetermined size or dimension, and the typical socket wrench may not be used to rotate or drive various nuts or fasteners or tool members of different dimensions or sizes.

U.S. Pat. No. 1,746,387 to Faw discloses a further typical socket wrench connection comprising a handle shank coupled to a wrench head or socket member for engaging with and for driving or rotating the nut or fastener or other tool member.

However, similarly, the socket opening of the socket member may only be used to receive or engage with a nut or fastener or tool member of a predetermined size or dimension, and the typical socket wrench may not be used to rotate or drive various nuts or fasteners or tool members of different dimensions or sizes.

U.S. Pat. No. 5,086,674 to Her discloses a still further typical socket wrench tool comprising a spoon-shaped handle member coupled to a tubular body for engaging with and for driving or rotating the nuts or fasteners or other tool members of different dimensions or sizes.

However, the socket openings of the typical socket wrench tool may only be used to receive or engage with a short length nut or fastener or tool member, but may not be used to rotate or drive various screws or bolts or fasteners or tool members of a greater length.

U.S. Pat. No. 5,807,499 to Martinez discloses a still further typical socket drive tool comprising a drive member formed or provided on one end of a drive shaft, and a socket member pivotally or rotatably coupled to the other end of the drive shaft with a stable universal coupling.

However, the universal coupling may greatly increase the manufacturing cost for the typical socket drive tool, and the drive member and the socket member may only be used to receive or engage with the limited nuts or fasteners or tool members.

U.S. Pat. No. 6,692,178 to Yu discloses a still further typical pivotal tool or socket drive tool comprising a pair of pivotally interconnected arms disposed in a crossing relationship and having a manually releasable releasing device for locking the arms in a perpendicular open position for use as a wrench.

However, the manually releasable releasing device may also greatly increase the manufacturing cost for the typical pivotal tool or socket drive tool, and the drive or socket members formed or provided on the free end portions of the arms may only be used to receive or engage with a short length nut or fastener or tool member, but may not be used to rotate or drive various screws or bolts or fasteners or tool members of a greater length.

The present invention has arisen to mitigate and/or obviate the afore-described disadvantages of the conventional socket wrench assemblies.

### SUMMARY OF THE INVENTION

The primary objective of the present invention is to provide a socket wrench assembly including three extensions secured together and having socket members of different dimensions or sizes or socket openings for driving tool members of different dimensions or sizes.

In accordance with one aspect of the invention, there is provided a socket wrench assembly comprising a first drive shank including a bore formed therein, and including a first end and a second end, a first socket member including a first end portion attached and secured to the second end of the first drive shank, and including a compartment formed in the first end portion thereof, and including a second end portion having a non-circular chamber formed therein and having an inner diameter greater than that of the compartment of the first socket member for forming an inner peripheral shoulder in the first socket member, a second drive shank including a bore formed therein, and including a first end and a second end, a second socket member including a first end portion attached and secured to the second end of the second drive shank, and including a compartment formed in the first end portion thereof, and including a second end portion having a non-circular chamber formed therein and having an inner diameter greater than that of the compartment of the second socket member for forming an inner peripheral shoulder in the second socket member, a third drive shank including a bore formed therein, and including a first end and a second end, and a third socket member including a first end portion attached and secured to the second end of the third drive shank, and including a compartment formed in the first end portion thereof, and including a second end portion having a non-circular chamber formed therein and having an inner diameter greater than that of the compartment of the third socket member for forming an inner peripheral shoulder in the third socket member, and the first end portions of the first and the second and the third drive shanks are secured together, and the chambers of the first and the second and the third socket members include inner diameters different from each other for receiving or engaging with or for driving tool members of different dimensions or sizes.

The first and the second and the third drive shanks each include an end cap formed and provided on the first end portion thereof. The chambers of the first and the second and the third socket members each preferably include a hexagonal cross section for suitably driving tool members.

The first and the second and the third socket members each include an end wall formed and provided on the first end portion thereof and removed after the first and the second and the third socket members are secured to the first and the second and the third drive shanks respectively.

The first and the second and the third drive shanks are secured together to form a Y-shaped structure, or to form a T-shaped structure for allowing either of the drive shanks to be driven or rotated by the other drive shanks with a greater driving torque.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of a socket wrench assembly in accordance with the present invention;

FIG. 2 is a cross sectional and partial exploded view of the socket wrench assembly;

FIGS. 3, 4 are cross sectional and partial exploded views similar to FIG. 2 illustrating the operation or the manufacturing of the socket wrench assembly;

FIG. 5 is a cross sectional view similar to FIG. 1 illustrating the other arrangement of the socket wrench assembly;

FIG. 6 is a cross sectional and partial exploded view of the socket wrench assembly as shown in FIG. 5;

FIG. 7 is a perspective view illustrating the further arrangement of the socket wrench assembly;

FIG. 8 is a cross sectional view of the socket wrench assembly taken along lines 8-8 of FIG. 7;

FIG. 9 is a perspective view similar to FIG. 7 illustrating the manufacturing or formation of the socket wrench assembly as shown in FIGS. 7-8;

FIG. 10 is a cross sectional view of the socket wrench assembly taken along lines 10-10 of FIG. 9; and

FIG. 11 is a partial perspective view illustrating the tool members to be driven or rotated by the socket wrench assembly in accordance with the present invention.

### DETAILED DESCRIPTION OF THE PREFERRED EMBODIMENT

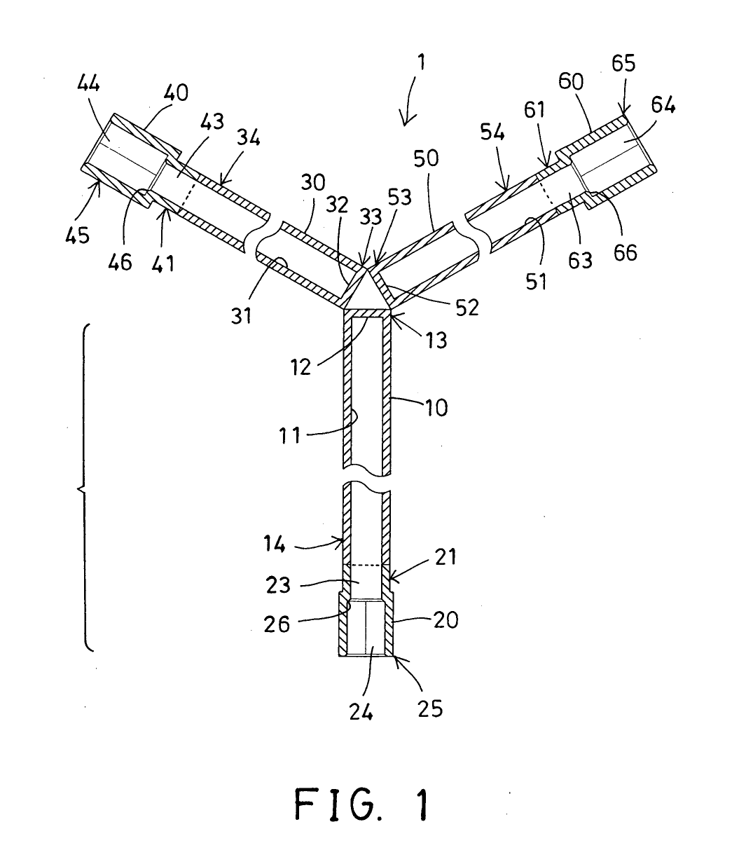

Referring to the drawings, and initially to FIG. 1, a socket wrench assembly 1 in accordance with the present invention comprises a first, a second, a third, or three extensions or drive shanks 10, 30, 50 each including a bore 11, 31, 51 formed therein, and each including an end cap 12, 32, 52 formed or provided on one or first end or inner end portion 13, 33, 53 thereof for forming the blinded bore 11, 31, 51 therein, and each including an open outer end portion 14, 34, 54 for attaching or mounting or securing a socket member 20, 40, 60 respectively, in which the one ends or inner end portions 13, 33, 53 of the drive shanks 10, 30, 50 are solidly welded or secured together to form the T or Y-shaped structure.

The socket members 20, 40, 60 each include one end or inner end portion 21, 41, 61 solidly welded or secured to the outer or second end portions 14, 34, 54 of the drive shanks 10, 30, 50 respectively, and each preferably include an end wall 22, 42, 62 formed or provided on one end or inner end portion 21, 41, 61 thereof, and each include a compartment 23, 43, 63 formed in the inner end portion 21, 41, 61 thereof, and each include an enlarged chamber 24, 44, 64 formed in the other or outer end portion 25, 45, 65 and having an inner diameter or size or dimension greater than that of the compartment 23, 43, 63 thereof for forming an inner peripheral shoulder 26 therein and located between the smaller compartment 23, 43, 63 and the greater or enlarged chamber 24, 44, 64 thereof.

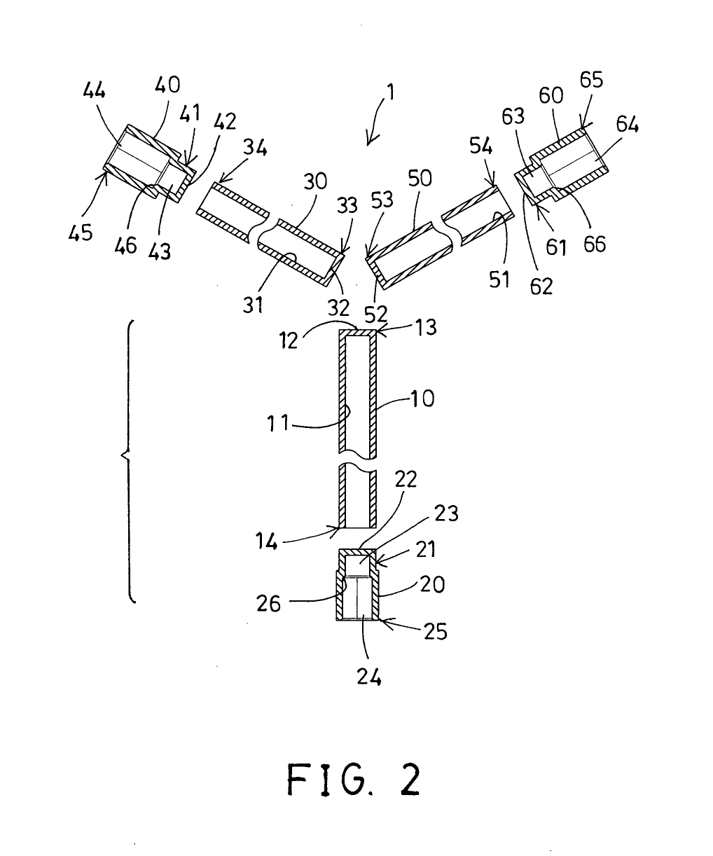

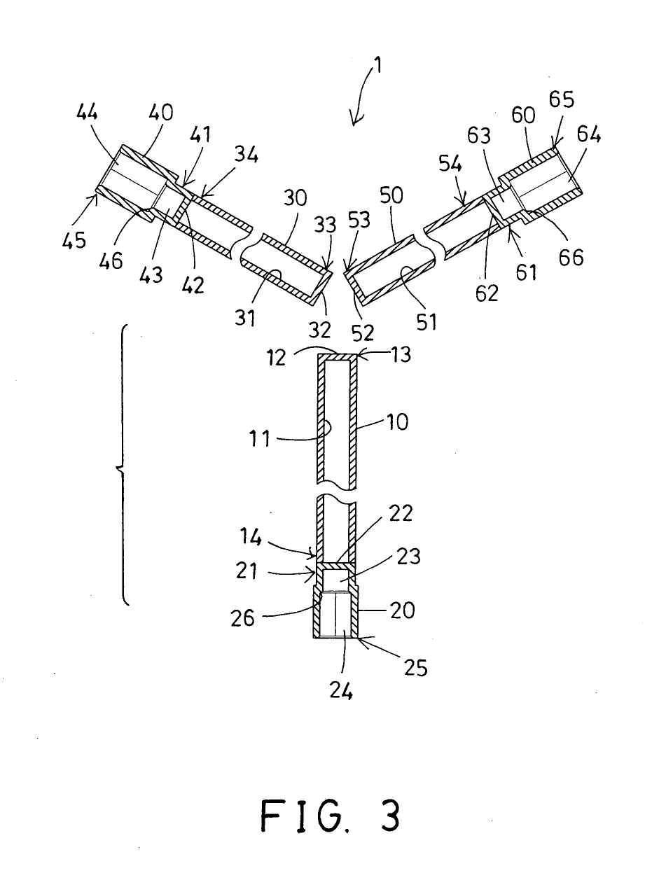

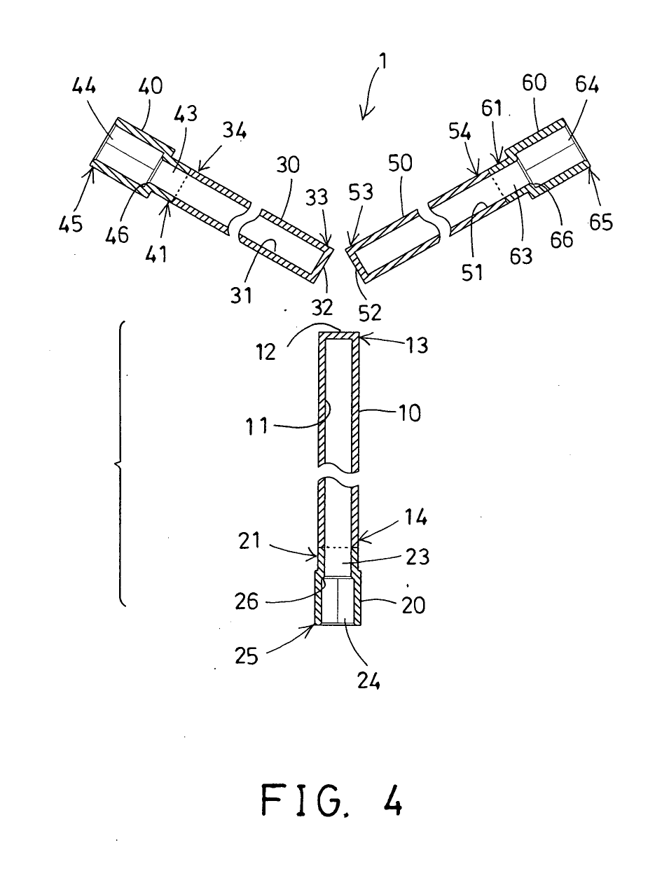

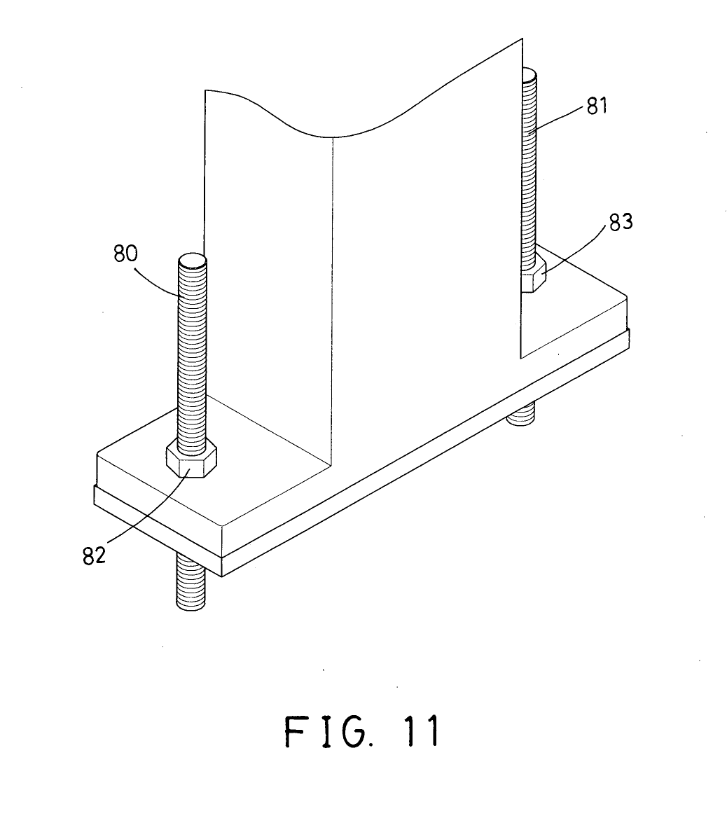

As shown in FIGS. 2-4, in manufacturing or forming the socket wrench assembly 1, the drive shanks 10, 30, 50 are separated from each other and then solidly welded or secured together to form the T or Y-shaped structure (FIG. 1), the inner end portions 21, 41, 61 are solidly welded or secured to the outer end portions 14, 34, 54 of the drive shanks 10, 30, 50 respectively (FIG. 3), and the end walls 22, 42, 62 of the socket members 20, 40, 60 may then be drilled or removed from the socket members 20, 40, 60 (FIG. 4) for allowing the compartment 23, 43, 63 of the socket member 20, 40, 60 to be communicative with the bore 11, 31, 51 of the drive shank 10, 30, 50 respectively and for receiving or engaging with the screws or bolts or fasteners or tool members 80, 81 of a greater length (FIG. 11).

It is to be noted that the compartment 23, 43, 63 of the socket member 20, 40, 60 and the bore 11, 31, 51 of the drive shank 10, 30, 50 may include a square, circular or other cross sections for receiving or engaging with the screws or bolts or fasteners or tool members 80, 81, and the chamber 24, 44, 64 of the socket member 20, 40, 60 may include a square or other non-circular cross sections, such as the hexagonal cross section for receiving or engaging with the nuts or fasteners or other tool members 82, 83. The chambers 24, 44, 64 of the socket members 20, 40, 60 include sizes or dimensions different from each other for receiving or engaging with or for driving the tool members of different dimensions or sizes, and either of the drive shanks 10, 30, 50 may be driven or rotated by the other drive shanks 30, 50, 10 with a greater driving torque.

In operation, the compartment 23, 43, 63 of the socket member 20, 40, 60 and the bore 11, 31, 51 of the drive shank 10, 30, 50 are communicative with each other for forming a longer receiving space and for receiving or engaging with the screws or bolts or fasteners or tool members 80, 81 of the greater length and for allowing the screws or bolts or fasteners 80, 81 or tool members 82, 83 to be easily driven or rotated by either of the drive shanks 10, 30, 50, and when either of the drive shanks 10, 30, 50 is engaged with the nuts or screws or bolts or fasteners or tool members 80, 81, 82, 83, the drive shank 10, 30, 50 may be driven or rotated by the other drive shanks 30, 50, 10 with a greater driving torque.

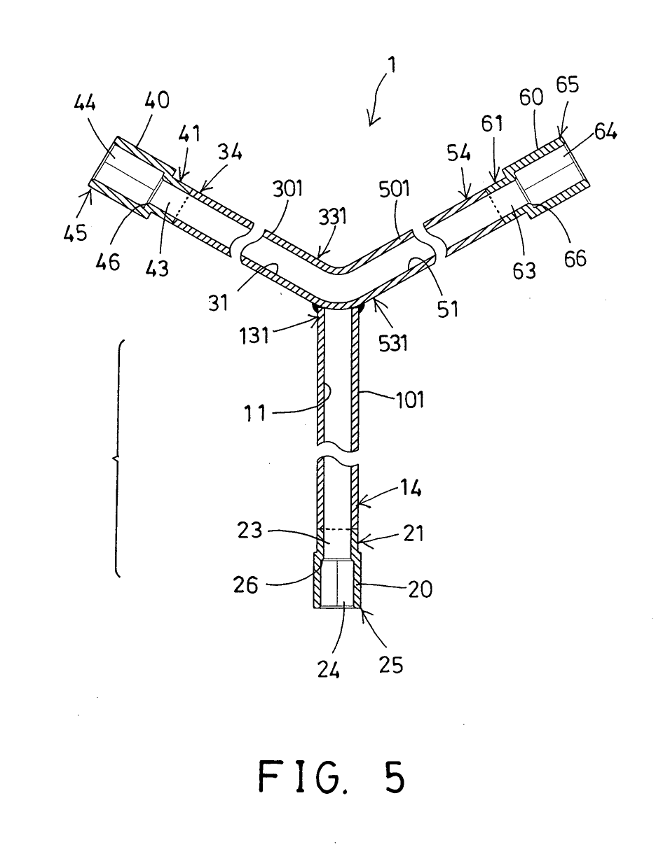

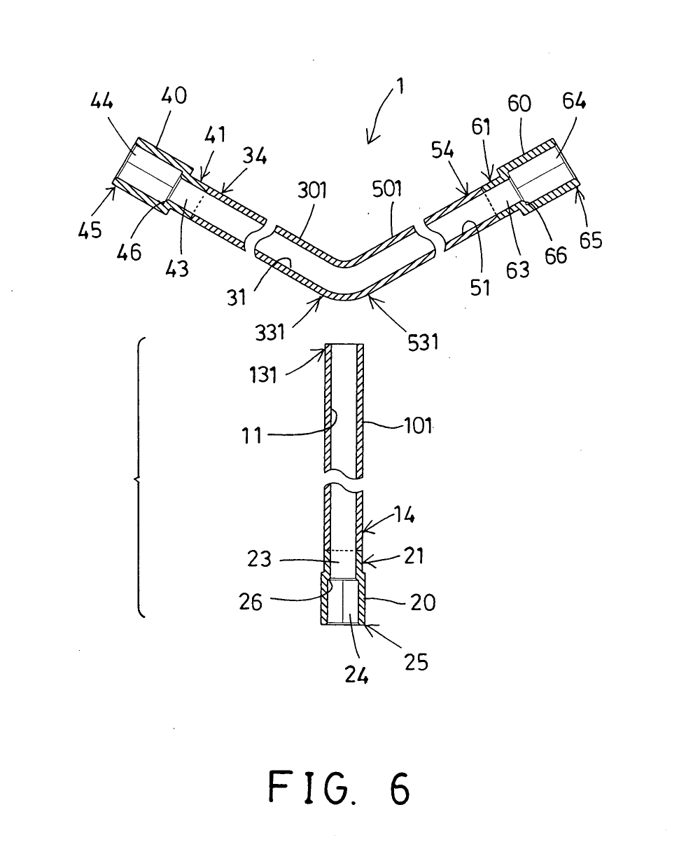

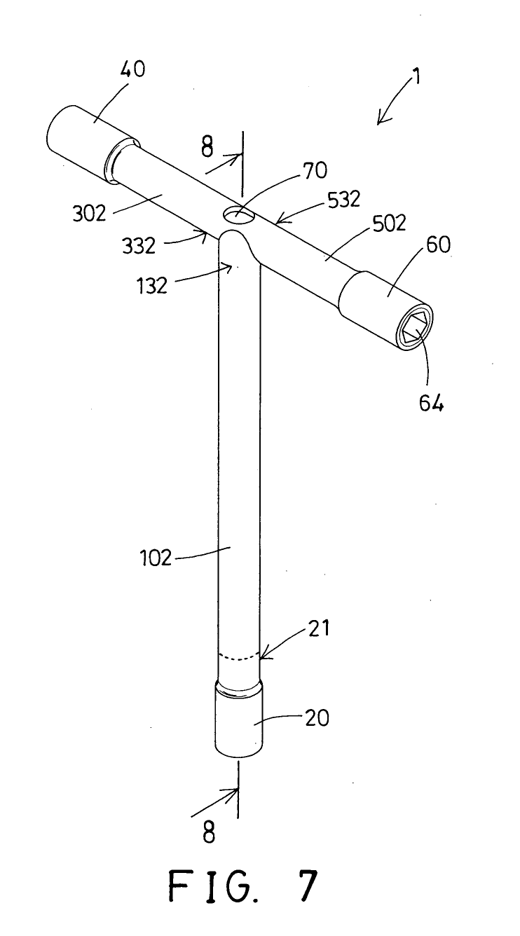

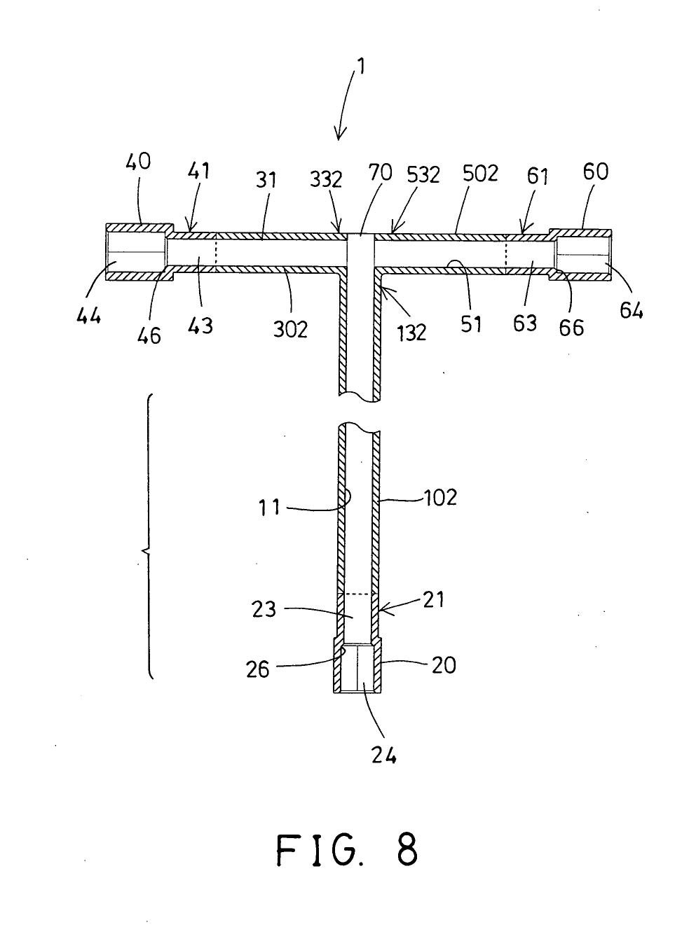

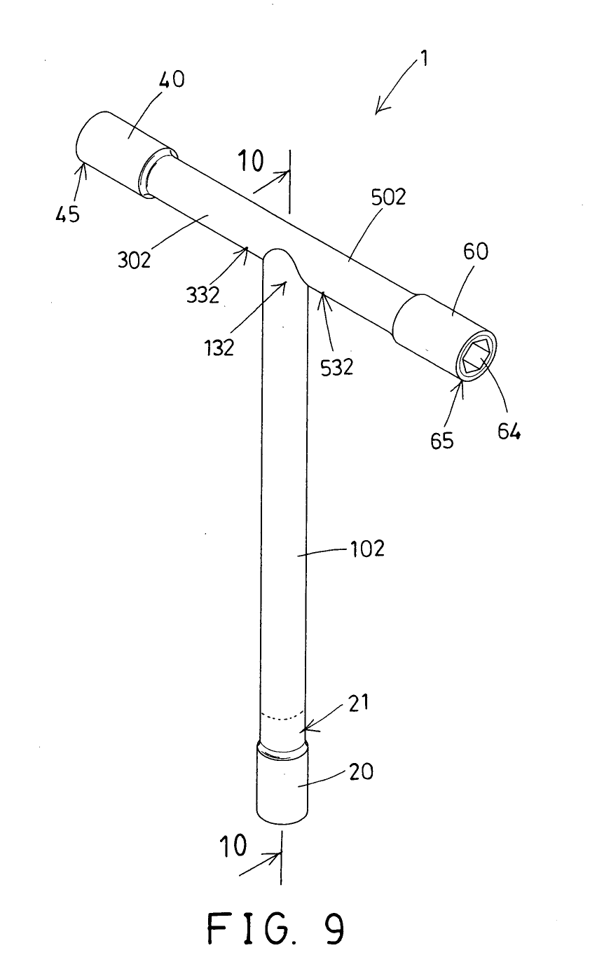

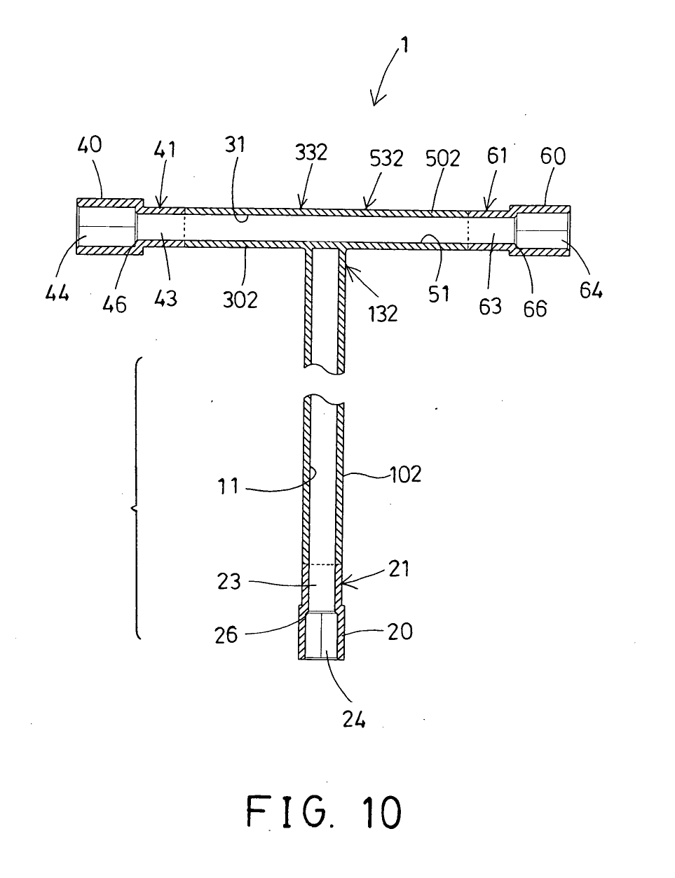

Alternatively, as shown in FIGS. 5 and 6, the inner end portion 131 of the drive shank 101 may include an opened structure, and the inner end portions 331, 531 of the other drive shanks 301, 501 may first be solidly welded or secured together to form the V-shaped structure, and then solidly welded or secured together to the open inner end portion 131 of the drive shank 101 for forming the Y-shaped structure. Further alternatively, as shown in FIGS. 7-10, the inner end portion 132 of the drive shank 102 may also include an opened structure, and the inner end portions 332, 532 of the other drive shanks 302, 502 may first be solidly welded or secured together or formed integral with each other to form the I-shaped or longitudinal structure, and then solidly welded or secured together to the open inner end portion 132 of the drive shank 102 for forming the T-shaped structure, and may include an aperture 70 formed between the inner end portions 332, 532 of the other drive shanks 302, 502 and communicative with the bore 11, 31, 51 of the drive shank 102, 302, 502 respectively.

Accordingly, the socket wrench assembly in accordance with the present invention includes three extensions secured together and having socket members of different dimensions or sizes or socket openings for driving the tool members of different dimensions or sizes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A socket wrench assembly comprising:
a first drive shank including a bore formed therein, and including a first end and a second end,
a first socket member including a first end portion attached and secured to said second end of said first drive shank, and including a compartment formed in said first end portion thereof, and including a second end portion having a non-circular chamber formed therein and having an inner diameter greater than that of said compartment of said first socket member for forming an inner peripheral shoulder in said first socket member,
a second drive shank including a bore formed therein, and including a first end and a second end,
a second socket member including a first end portion attached and secured to said second end of said second drive shank, and including a compartment formed in said first end portion thereof, and including a second end portion having a non-circular chamber formed therein and having an inner diameter greater than that of said compartment of said second socket member for forming an inner peripheral shoulder in said second socket member,
a third drive shank including a bore formed therein, and including a first end and a second end, and
a third socket member including a first end portion attached and secured to said second end of said third drive shank, and including a compartment formed in said first end portion thereof, and including a second end portion having a non-circular chamber formed therein and having an inner diameter greater than that of said compartment of said third socket member for forming an inner peripheral shoulder in said third socket member, and
said first end portions of said first and said second and said third drive shanks being secured together, and said chambers of said first and said second and said third socket members including inner diameters different from each other.

2. The socket wrench assembly as claimed in claim 1, wherein said first and said second and said third drive shanks each include an end cap formed and provided on said first end portion thereof.

3. The socket wrench assembly as claimed in claim 1, wherein said chambers of said first and said second and said third socket members each include a hexagonal cross section.

4. The socket wrench assembly as claimed in claim 1, wherein said first and said second and said third socket members each include an end wall formed and provided on said first end portion thereof and removed after said first and said second and said third socket members are secured to said first and said second and said third drive shanks respectively.

5. The socket wrench assembly as claimed in claim 1, wherein said first and said second and said third drive shanks are secured together to form a Y-shaped structure.

6. The socket wrench assembly as claimed in claim 1, wherein said first and said second and said third drive shanks are secured together to form a T-shaped structure.
